(19) United States
(12) Patent Application Publication
(10) Pub. No.: US 2010/0281546 A1
(43) Pub. Date: Nov. 4, 2010

(54) DATA LOSS AND THEFT PROTECTION METHOD

(75) Inventors: Ronald M. Kruse, Anoka, MN (US); Jacob R. Graf, Appleton, WI (US)

Correspondence Address: NIKOLAI & MERSEREAU, P.A., 900 SECOND AVENUE SOUTH, SUITE 820, MINNEAPOLIS, MN, 55402, US

(73) Assignee: RMCL, INC., Coon Rapids, MN (US)

(21) Appl. No.: 12/796,403

(22) Filed: Jun. 8, 2010

Related U.S. Application Data
(62) Division of application No. 11/542,069, filed on Oct. 3, 2006.

(51) Int. Cl. H04L 9/32; G06F 17/30

(52) U.S. Cl. 726/32; 726/27; 707/648; 707/E17.007

(57) ABSTRACT

Files stored on a non-removable storage device of a computer system are susceptible to being deleted and to theft. The present invention ensures that vital data files are not lost and that removable storage devices are not used to steal data.

### BACKGROUND OF THE INVENTION

I. Field of the Invention

The present invention relates generally to the security of computer systems. More specifically, the present invention protects such computer systems against the accidental or intentional deletion and theft of computer files of vital interest to a person or organization, as well as other misuse of the computer system.

II. Related Art

In today's society, most business organizations own and operate a computer system. Computer systems may be an individual personal computer or an integrated network including many different workstations and storage devices. Many homes are now equipped with one or more computers. Even in a home or small business environment, computer systems often times have many different users. Each of these users typically has the ability to delete or overwrite files stored on the computer system resulting in the loss of data that may be of critical importance to other computer users or an organization. Sometimes the deletion or overwriting of files is accidental. At other times, such activities are intentional and designed to disrupt the efforts of other computer users or a business organization.

In the past, individuals and organizations have implemented backup procedures to recover data in the event data is lost or corrupted due to disaster. Such a disaster could be flood, fire, failure of a storage device, a computer virus or the like. The intent of the backup procedures is to restore data to its pre-disaster condition. These backup procedures, however, offer only limited protection against accidental or even intentional deletion of a small number of important files for the reasons discussed below.

Backup procedures used today typically incorporate a cycle to reduce the cost of storage media used to back up the computer system. Such media is held for a specific period of time and then, if no problem has been detected, reused so that new media need not be acquired for each back up. The typical backup rotation allows a user to recover files from the backup media used so long as the files remain in tact. However, once the media is reused and the files on the backup media are overwritten, they can no longer be restored from the backup media. This is not an issue in the context of disasters such as a flood or failure of a storage device because the loss of data files is immediately recognized and the backup media can be preserved until the data files on the backup media can be restored to the computer system. However, when files are accidentally deleted or intentionally deleted by a disgruntled person, the deletion of a file may not be identified or discovered for an extended period of time. If the discovery of the deletion of the file occurs after one complete rotation of the backup media, the file will be lost forever.

For example, income tax returns are typically filed annually. Yet the backup cycle used for a computer may only be two weeks long. If a tax file is deleted, this may not be discovered until the next year's tax return needs to be prepared. In that one year time period the media used as part of the backup cycle may have been overwritten more than twenty times making it impossible to recover the deleted file.

Accordingly, there is clearly a need in the art for a system and method which may be employed to discover and prevent the permanent deletion of files that are vital to an individual or organization.

Another problem faced by the proprietors of many computer systems is theft of data. This problem has become particularly acute with the advent of small, inexpensive, removable storage devices that can hold large quantities of data. A variety of such devices exist that are easily concealed and transported. These devices have any number of legitimate uses. Computers are commonly equipped to work with such devices. Such devices are generally referred to herein as removable storage devices. Such devices differ from non-removable storage devices such as a hard drive located within the case of a computer.

One type of removable storage device is a disk such as a CD or DVD. Most computer workstations sold today are equipped with a drive that allows data to be written to a removable storage device such as a CD or DVD.

A second type of removable storage device is a storage device designed to be attached to a port of the computer system. Most computer workstations are equipped with serial, parallel, USB or fire wire ports. Various removable storage devices such as flash drives and portable hard drives are designed, for example, to be attached to a port of a computer. This permits data files to be quickly and easily copied to or from such a device. Flash drives capable of storing 65 GB of data are now readily available. Western Digital's Model WDGIT5000N external hard drive, which sells for under $350.00, holds 555 GB of data, is designed to look like a book and fits easily within any brief case. This represents enough storage capacity to permit one to steal thousands of vital data files. The speed with which data can be copied to such devices would permit someone with access to a computer for only a few short minutes to steal all the files they would want.

A third type of removable storage device is a data storage card such as CompactFlash, Secure Digital (SD) cards, Memory Sticks, and SmartMedia cards. A 2 GB Memory Stick can now be purchased for under $150.00. These devices, while most often used in digital cameras, can be quickly and easily used to steal important data. Various drives can be attached to computer systems that permit data files to be copied to and from such data cards.

These are just a few types of removable storage devices readily available today. These examples are not intended to be limiting as to the meaning of “removable storage device”. This term is intended to include any device to which data can readily be copied which is transportable. In view of the foregoing, there is clear need to protect data stored on computer systems from theft committed through the use of removable storage devices.

Additionally, if a computer accesses such storage devices, other dangers exist. The storage device could contain viruses, spyware, ad ware or other programs or files that could damage the computer system or be used to breach other security measures. Programs and other files stored on a removable storage device can also lead to unauthorized use of the computer. Examples of such unauthorized use include, but are not limited to, playing games, viewing pornography or listening to music or playing videos inappropriate for use in the workplace. Such use not only results in lost work time for which an employee is paid, but could even lead to harassment claims if, for example, viewing pornography is left unchecked. Such problems arise in environments other than the workplace including schools, libraries and other places where computers are made available. Thus, there is a need to address such risks and prevent such unauthorized use.

### SUMMARY OF THE INVENTION

The present invention provides a software controlled method for ensuring that vital computer files are not deleted or overwritten on a storage device either accidentally, by a virus, or by an individual who wishes to disrupt the activities of users needing the files. The software can be embedded in the firm ware of the computer system or located on any storage device of the computer system. In fact, if the software is being used to protect files on a non-read only removable storage device, the software itself can be stored on the removable storage device. This would be done if it is desired to protect files stored in the removable storage device from accidental deletion. The method of the present invention involves identifying the characteristics of files that may be vital to an organization or user. This method also involves storing parameters on the computer system that the computer system can compare to files to be deleted to identify which files may be vital to the organization. This method also involves creating a recovery directory, sometimes referred to as a dump folder or dump directory, on a storage device of the computer system. This method involves limiting access to that recovery directory such that no one other than a trusted, authorized user can either overwrite or delete files contained in that directory.

Periodically, the computer system will receive an instruction to delete a file from a storage device of the computer system. Such a storage device could be a hard drive of the computer system or any other non-read only storage device built into, or attached to or inserted into a drive of the computer system. Such an instruction may be the result of legitimate action, accident, deliberate conduct intended to do harm, a virus or the like. When the computer receives such an instruction, it compares the attributes of the file to be deleted with the parameters that have been stored. If the attributes of the file do not match the parameters that have been stored, the file is simply deleted. If, on the other hand, there is a match, the file either is moved to the recovery directory or a copy of the file is created and stored in the recovery directory prior to the file being deleted from the storage device. For convenience, multiple recovery directories can be used. Which recovery directory is used when a file is deleted can depend on the user deleting the file, the location of the file deleted or any of a variety of other factors. For example, if the file is located on a removable storage device, the recovery directory can also be located either on the removable storage'device itself or some other storage device.

Also, the present invention records and stores various types of information related to the deletion instruction. Such information includes data related to the source of the instruction, e.g., the name of the user logged into the computer, the identity of a workstation on a computer system that issued the instruction, or the like. Such information also includes the date and time the instruction was delivered to the computer, as well as the name and type of the file which was the subject of the instruction.

From this point, various techniques can be used to evaluate the contents of the recovery directory to decide which files are vital and should be restored to their original location and which files are not vital and simply can be deleted. The computer system can use the information that was recorded related to the file deletion to formulate an automatic e-mail that would be sent to a system administrator advising the system administrator of the deletion. The system administrator can then access the copy of the file stored in the recovery directory to determine whether the file should be restored to its original location or deleted. Alternatively, no message is sent to the administrator, but the administrator will periodically review the contents of the recovery directory and make a similar determination related to each file stored therein. A log containing the collected information related to deleted files can be used by the administrator in this process and to take appropriate action with someone who tried to delete a file that should not have been deleted. Such action can be additional training, further restricting the person's access to files on the computer, dismissal of the person from the employ of the company, or even commencing civil and criminal legal proceedings.

A key benefit of the present invention is that no files of importance can be deleted by a single individual. Also, periodic review by an administrator should ensure that all vital files are restored to their original location before backup media is recycled and thereby overwritten. So long as this periodic review occurs more frequently than the duration of the backup cycle, the system should be secured against unintentional or intentional deletion of vital files. Of course, it is still important for a trusted individual to serve as the administrator because this person ultimately serves as a road block against the problem articulated above.

In some cases, it may be necessary to ensure that an administrator is not the same person monitoring the files the administrator deletes. In this case, a separate dump folder, i.e., recovery directory, can be created for each administrator and only some other administrator is allowed to restore and delete from a particular administrator's dump folder. Messages related to one administrator's efforts to delete files would then be sent to another administrator.

The present invention also protects against unauthorized use of removable storage devices and prevents these devices from being used as an instrument of theft. The present invention senses whenever such a device is inserted into the drive of a computer or attached to a port of a computer. The present invention then renders inoperable all user input devices to the computer (e.g., the keyboard and mouse) to prevent copying of files to the removable storage device. At the same time, a message is sent to an administrator and an audible alarm may sound. Only when the removable storage device is removed, is functionality restored to the user input devices.

As noted above, there are legitimate uses for removable storage devices. Thus, the system of the present invention provides for password protected user accounts to permit use of such devices. Such accounts, when set up, can be restricted to a specific time period, may be designed to deactivate after a single use, and can be restricted so that only specifically authorized files can be copies to the removable storage device. After logging in to the temporary user account, the user can insert the removable storage device and make the authorized copies. These same safeguards provided by the present invention assist in preventing unauthorized use of the computer and copying of unauthorized files and programs to the computer.

These and additional objects, advantages and features and benefits of the present invention will become more apparent from the following detailed description of the preferred embodiments in view of the accompanying drawings.

### BRIEF DESCRIPTION OF THE DRAWINGS

FIG. 1 is a schematic diagram of a server.

FIG. 2 is a schematic diagram of a peer to peer network.

FIG. 3 is a flow chart showing how the present invention is set up.

FIG. 4 is a flow chart showing how the present invention protects files from deletion.

FIG. 5 is a flow chart showing how the present invention protects files from theft.

FIG. 6 is a flow chart showing how the present invention protects files from theft yet permits authorized use of removable storage devices.

### DETAILED DESCRIPTION OF THE PREFERRED EMBODIMENT

The security system of the present invention will most typically be used to protect data stored on a network that is accessible by a plurality of users via workstations connected to the network. The security system of the present invention can also be deployed to secure data stored on a single computer used by more than one individual.

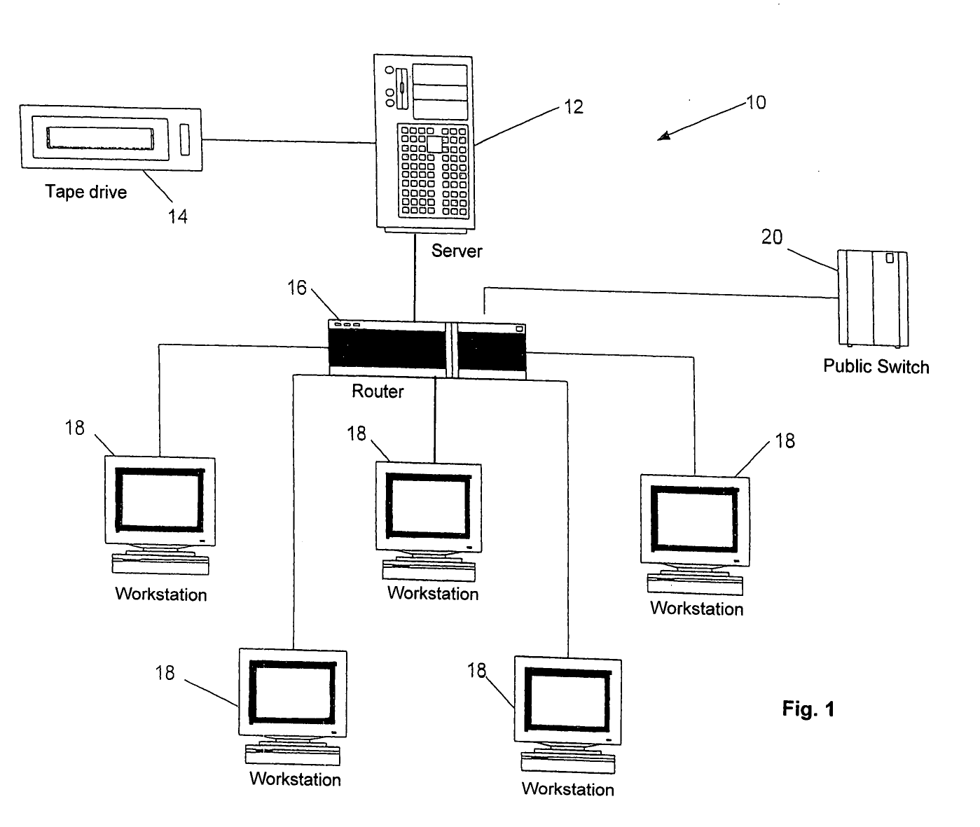

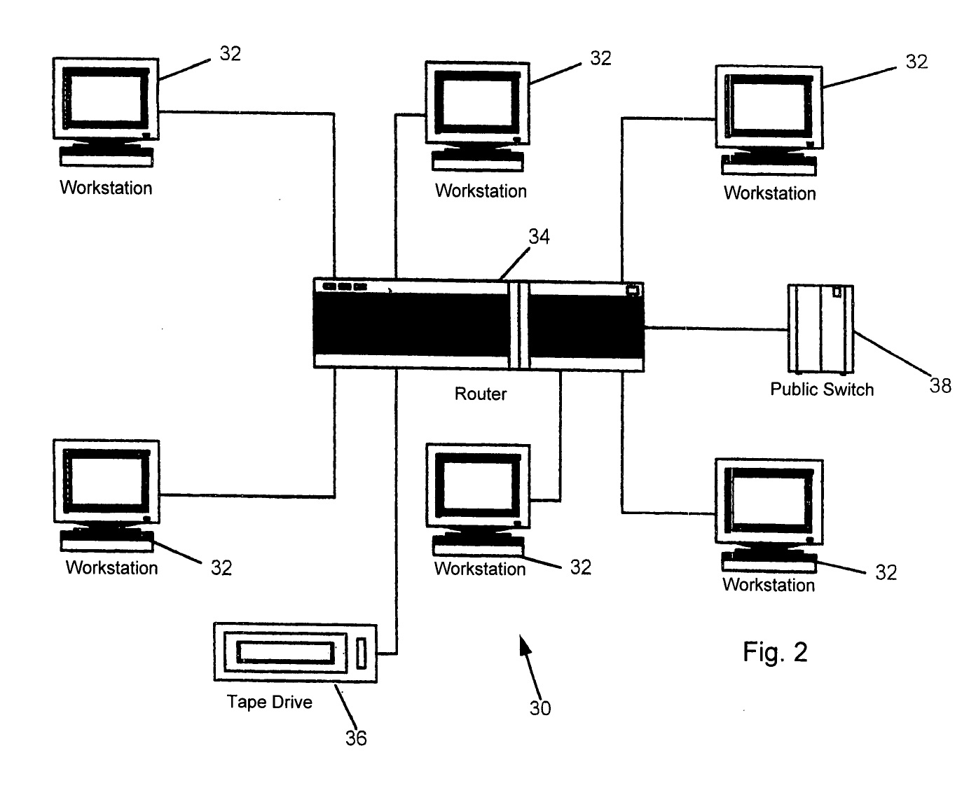

FIGS. 1 and 2 provide examples of two typical networks with which the security system of the present invention can be used. The network 10 depicted in FIG. 1 is a server based network wherein data is primarily stored in a shared manner on a file server 12. Any number of workstations can communicate with the file server to save and retrieve data via a router or switch 16. Five workstations 18 are shown. Each workstation 18 includes a CPU, a monitor, a keyboard, a mouse, adequate memory, a storage device, one or more drives for reading or writing to removable storage media, and one or more ports (e.g., USB or firewall ports) for connecting devices to the workstation 18 as used herein such ports and devices are collectively referred to as writing devices. The workstation will also include a network card or equivalent device which may be wired or wireless. A gateway (not shown) can also be provided to control traffic between the network 10 and external devices. The network would typically be attached via the gateway to a public switch 20 to provide a link to the Internet. The gateway is protected by a firewall that precludes unauthorized access to the network from the outside and unauthorized transmission of data from the outside to the inside. FIG. 1 also includes a tape drive 14 for backing up the storage devices in the network 10. Those skilled in the art will appreciate that while tape drive 14 is shown as part of network 10, it could also be a remote storage system coupled to the network 10 via the Internet through public switch 20. Also, other backup devices could be used in lieu of the tape drive 14.

FIG. 2 shows a network 30 which comprises six workstations 32 all connected to each other via a router or switch 34. This arrangement permits files to be created, shared, edited, and stored, or deleted by any workstation 32 on the storage device (e.g., hard drive) of any workstation 32. The network 30 also includes a backup tape drive device 36 connected to each of the workstations 32 via the router/switch 34 so that the storage devices on each of the workstations can be backed up. Also shown is a public switch 38 to permit communication with remote devices which may include a remote backup device.

A significant problem associated with all networks, not just those shown in FIGS. 1 and 2, is the risk of accidental or intentional but unauthorized deletion of data. Other risks relate to theft of data. The present invention solves such problems:

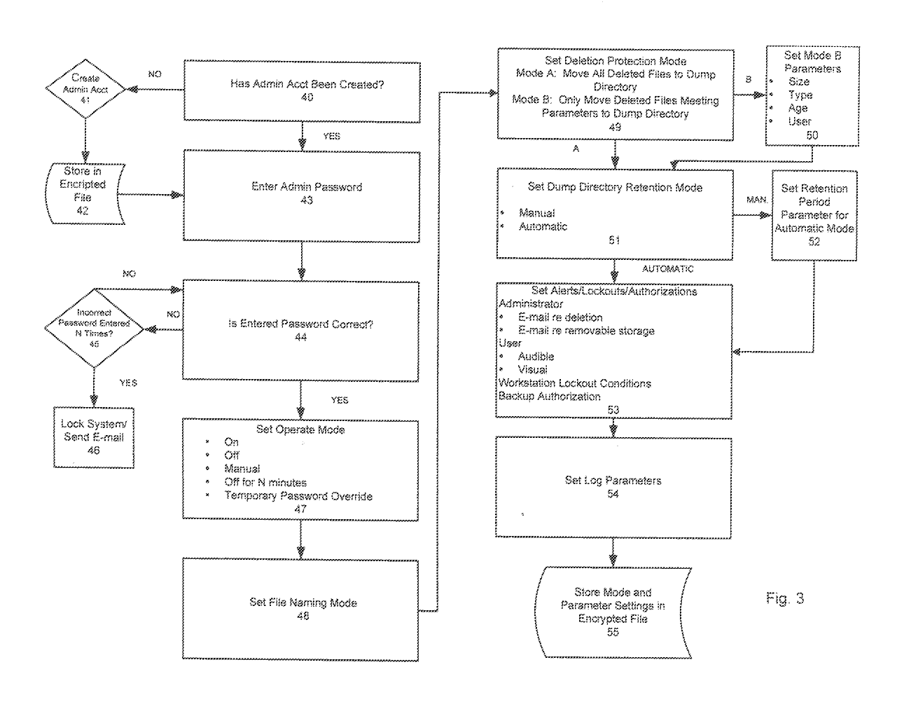

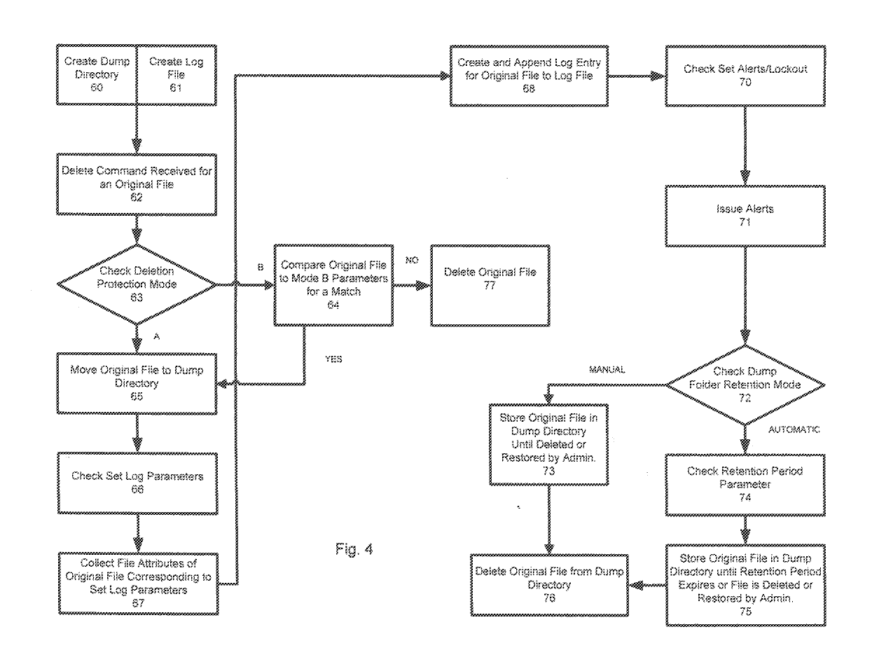

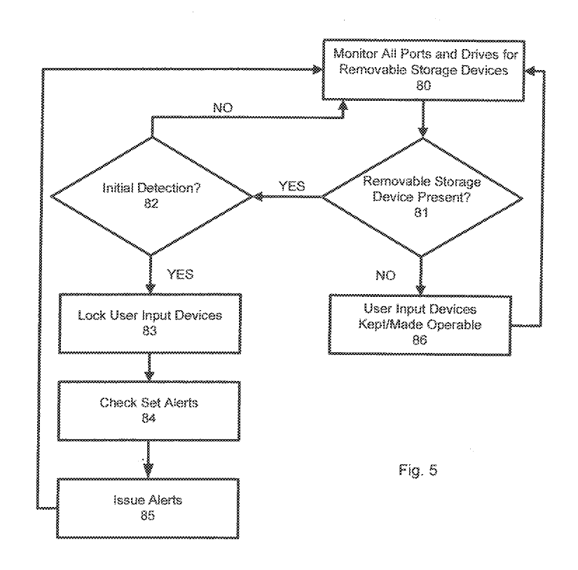

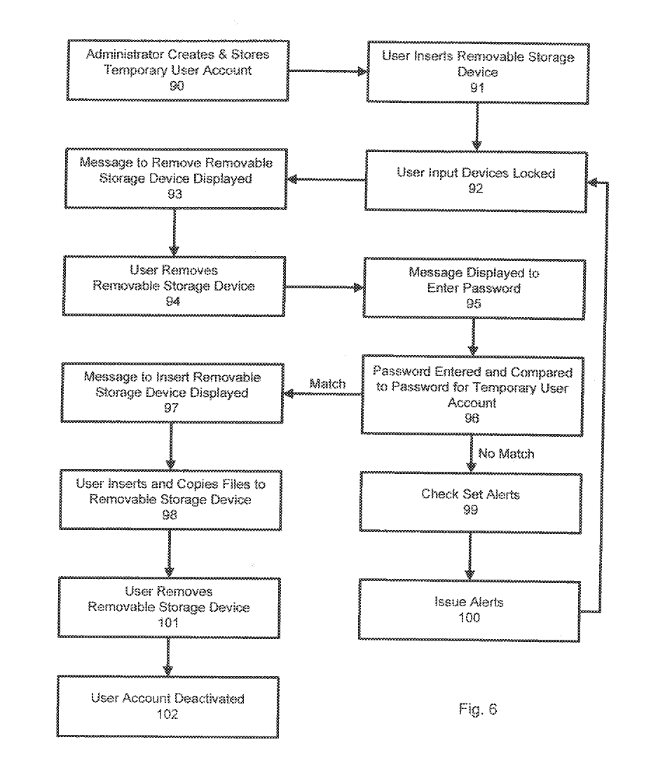

FIGS. 3-6 are flow charts depicting the system and method of the present invention. FIG. 3 depicts the administrative set up and controls provided by the invention. FIG. 4 depicts the way the system protects against unintentional or unauthorized deletion of files. FIG. 5 depicts the way the system protects against theft of data. FIG. 6 depicts the way the system can protect against theft of data and at the same time permit authorized use of removable storage devices.

As reflected in FIG. 3, the system of the present invention permits substantial control by a system administrator. This can be the owner of a small business or a highly trusted member of a business organization. It can also be an individual who owns a computer.

To ensure that no one other than the administrator can alter the mode of operation or other parameters used by the system, the system first checks at step 40 to see if an administrative account has been created. If not, the administrator is prompted at step 41 to provide the data necessary to establish such an account. Such data, at a minimum, will include a password and an e-mail address for the administrator. It will also typically include a parameter related to the number of unsuccessful login attempts to be permitted if in the future someone tries to gain access using a password other than the administrative password. Once this account has been created, the data associated with the account is stored in an encrypted file at step 42 and the administrator is asked to enter the password at step 43.

At step 44, the system compares the password entered to the administrative password stored in the encrypted file at step 42. If there is a match, the program continues on to step 47. If there is not a match, the program proceeds to step 45 and checks to see whether the number of unsuccessful attempts to enter the stored password matches or exceeds the parameter contained in the administrative account file, for example three. If the threshold established by this parameter is not met, the program returns to step 43 and the user is again prompted to enter the password. If this threshold is met, the program proceeds to step 46 which locks access to the set-up subroutine for a predetermined period of time and sends an e-mail notification to the e-mail address of the administrator using the address identified and stored in steps 41 and 42.

Once the correct password has been entered, the program proceeds to step 47. At step 47, the administrator can select from various operating modes. The administrator can turn the protection system on or off. If the system is “on”, the administrator can elect to have the system run automatically or manually. The administrator can also elect to have the system off for a predetermined period of time and then automatically restart. Likewise, the administrator can elect to have the system shut down after a predetermined period of time. The administrator can also assign a temporary password that a user can use to bypass certain protections offered by the system for a predetermined period of time. This password is associated with a temporary user account having settings that permit the administrator to control what can and cannot be done using the account. At step 49, the administrator selects from various naming modes, the purpose of which is discussed below.

In addition to establishing the operate mode at step 47 and file naming mode in step 48, the administrator can select from various deletion modes at step 49. Specifically, the administrator can elect to have all deleted files moved to a recovery directory (a.k.a. dump directory) or only those meeting certain parameters moved to the recovery directory. Such parameters are set at step 50. For example, a minimum file size can be set so only files exceeding that size are stored in the dump directory. Different minimum file size parameters can be defined for different network users, files of differing ages, or files of different types (e.g., word processing, spreadsheets, photos, music, etc.). Other parameters can also be used to identify which files should and should not be moved to a dump directory.

The naming mode set at step 48 prevents deletion of files stored in the dump directory by overwriting the file. Ordinarily the copies of files stored in the dump directory will be given the same name as the original so they can be simply cut and pasted back to their original location if improperly deleted. However, if a file to be deleted has the same name as a file already in the dump directory, an extension will be added to the file then being deleted before it is copied to the dump directory to prevent overwriting. Step 48 allows the administrator to establish a naming convention to be used in creating such extensions.

Step 51 permits the administrator to select a retention mode for files stored in the dump directory. If the manual mode is selected, files will stay in the dump directory until deleted manually by the administrator. If the automatic mode is selected, files stored in the dump directory are kept for a predetermined period of time and then automatically deleted unless manually restored to their original location prior to the expiration of that predetermined time period. The time period parameter for automatic deletion is set at step 52.

Step 53 allows the administrator to define which types of alerts and actions are generated by the protection system. Such alerts include both administrator alerts and user alerts. Such alerts can take the form of e-mails, audio alerts via a workstation speaker, and visual alerts via the display of a workstation. The system can also act to lock up the keyboard and mouse of a workstation if a violation occurs at that workstation or otherwise render an unauthorized removable storage device (or a part or drive to which it is attached) inoperable. Additionally, at step 53, the administrator provides certain parameters related to authorization of backups by a backup storage device such as, for example, tape drives 14 and 36 shown in FIGS. 1 and 2. It is important that the computer system be able to create regular backups of data files stored on the computer system. Thus, the backup devices will only physically be accessible by a trusted employee such as an administrator to prevent unauthorized media from being used in such devices. The setup options can also be used to control which specific media can be used with the storage device such that, for example, insertion of an unauthorized tape into a tape drive would prevent the tape drive from operating either to permit files to be copied to the tape or to permit files to be copied from the tape.

At step 54, the administrator can identify data to be included when the system automatically logs and reports file deletions or other violations detected by the system. Such data would typically include date, time, the physical address of the network device, the identity of the user logged in at the device, and the identity of a file deleted or nature of the violation.

Once all the operating modes and parameters have been set, they are stored in an encrypted and right protected configuration file at step 55, thus completing the setup process. In the event the configuration file becomes corrupted or the administrator forgets the administrator password, this configuration file may be temporarily replaced by a universal configuration file stored on a remote server or a utility can be provided to reset the password. Both the universal configuration file and the utility to reset the password are subjected to strict security measures.

FIG. 4-6 are block diagrams showing the three operational subroutines of the system. FIG. 4 shows a subroutine used by the system to prevent loss of data. FIG. 5 shows a subroutine used by the system to prevent theft of data. FIG. 6 shows a subroutine that allows the protections afforded to prevent theft of data to be overridden so that data can be stored on removable storage devices when such storage is to be used for an authorized purpose.

As shown in FIG. 4 when the system is in operation, both a dump directory and a log file are created. See steps 60 and 61. These are both right protected so only the administrator has access. While the system will copy files to be deleted to the dump directory, only the administrator can restore, edit, or delete files in the dump directory. The remaining steps of FIG. 4 track the life of a file to be deleted.

At step 62 a command is received to delete an original file. The system then checks at step 63 to see if the system was set up at step 49 to operate in deletion mode A wherein all files to be deleted are first moved to a dump directory or in deletion mode B wherein only files meeting the parameters set at step 50 are to be moved to the dump directory. If the system is in deletion mode A, the program proceeds directly to step 65. If the system is in deletion mode B, the system proceeds to step 64 wherein the attributes of the file to be deleted are compared to the file deletion parameters set at step 50. If there is a match, the program proceeds to step 65 where the original file is moved to the dump directory. Alternatively, the original file may be copied to the dump directory and then deleted. If there is not a match, the program proceeds to step 77 and the file is deleted.

As shown, whenever a file to be deleted is moved, to the dump directory, the system creates a log entry. Those skilled in the art will recognize from the following that such log entries can instead be created for every file deleted if so desired. As shown in FIG. 4, log entries are created by first checking the log parameters set at step 54 during set up, collecting attributes of the original file to be deleted corresponding to such parameters and then appending a log entry to the log file created at step 61. See steps 66-68. At step 70, the system checks which alerts were set at step 53 and issues corresponding alerts at step 71 to the administrator and/or user as defined by the parameters established at step 53.

The remainder of FIG. 4 relates to the retention of the copies of files moved or copied to the dump directory at step 65. At step 72, the system checks to see whether it is in the manual or automatic retention mode. If it is in the manual retention mode, the program stores the file in the dump directory until the administrator “cuts and pastes” it back to its original storage location or deletes the file from the dump directory. See step 73.

If the system is in the automatic retention mode, at step 74 the system checks the retention period parameter set at step 52. The system will continue to store the file in the dump directory until the expiration of the retention period set at step 52, unless the administrator first deletes the file or restores the file to its original (or some other) storage location. At the end, of the retention period, for any file that has not been deleted or restored, the program moves from step 75 to step 76 and the original file (or copy) is deleted from the dump directory. While not shown in FIG. 4, the system can issue periodic warnings during the set retention period to remind the administrator to take action before the copy of the file is automatically deleted from the dump folder. In any event, if the automatic retention mode is used, the administrator should decide what set retention period to use based upon the backup cycle for the computer system. If the copy of a file is deleted from the dump folder, it will be lost forever once all the backup media that captured the file is overwritten, as part of the backup cycle.

As indicated above, any number of removable storage devices can be attached to a workstation and used to make copies of data stored on a network. Such devices include tape drives, floppy disk drives, and CD and DVD drives that are often built right into a workstation. Other devices can be attached to a port of a workstation such as a USB port, a serial port, a parallel port, or a fire wire port. Such devices include portable hard drives, USB flash drives and the like. Some workstations are also equipped with card slots that allow quick data transfer to and storage on a memory stick, compact flash card, or a smart memory card. Card readers can quickly be attached to the USE port to permit data storage and copying on such devices even if the workstation is not so equipped. The list of removable storage devices provided above is not exhaustive. Many others exist and are likely to be developed in the not so distant future. The present invention is designed to protect against theft using any removable storage device.

While there are legitimate reasons for using such devices, they can also be used to steal data from a network. The present invention includes a subroutine to protect against such theft. Two examples of such subroutines will now be described with reference to FIGS. 5 and 6.

In the embodiment shown in FIG. 5, the system has a first mode of operation wherein it monitors the ports and drives of the network or computer system. See step 80. If at step 82, the system detects the insertion of a removable storage device, most typically at a workstation, the system moves to step 82. This would also occur if the system detects the presence of such a device at start up of a workstation or some other network device. If this is the initial detection of the device three things then happen immediately. First, the operation of the computer system is modified based upon the settings input at step 53 to prevent copying of data files to or from an unauthorized removable storage device. As specifically shown in FIG. 5, at step 83 all user input devices of the workstation are frozen if the presence of an unauthorized removable storage device has been detected. Such user input devices include but are not limited to, a mouse, a keyboard, a touch screen monitor, etc. Second, at step 84, the system checks the configuration file to see which alerts were set at step 53. Third, the desired alerts are then generated and issued at step 85. Such alerts can include an immediate e-mail to the administrator, the sounding of an audio alert through the speaker of the workstation and/or the workstation of the administrator, or the generation of a visual message on the workstation display or the display of the administrator's workstation.

Once the unauthorized removable storage device is removed, the program advances to step 86 and the computer system returns to its first mode of operation wherein the user input devices are restored to their operational state. The program cycles back to step 80 where the process of monitoring continues. Those skilled in the art will recognize that remote input devices can control the operation of the workstation and the ports or drives of the workstation in which the removable storage device has been inserted. Such devices also remain locked from step 82 through step 85 as an additional measure against theft. Those skilled in the art will also recognize that as an alternative to locking the user input devices, the system can disable the port or drive to which the removable storage device was coupled until the device is removed.

As indicated above, there are legitimate uses of removable storage devices and the system of the present invention accommodates such use in several ways. First, the administrator can log, in and change the operate mode at step 47 to “off” to permit such removable storage devices to be used. Another option is for the administrator to authorize various drives or ports to be used with authorized media such as a tape backup drive physically accessible to only authorized personnel to be used in an authorized manner to create a backup. Another option would be for the administrator to log in and create a temporary user account and password. This approach is shown in greater detail in FIG. 6.

As shown in FIG. 6, the administrator sets up a user account that permits a specific user to use a removable storage device for a limited period of time and for a limited purpose. The user account is also password protected. This user account is set up and stored in the encrypted configuration file at the step labeled 90 in FIG. 6 which corresponds to 47 in FIG. 3. The user then connects a removable storage device to a workstation at step 91. As in FIG. 5, the system then locks the user inputs at step 92 and a message is displayed at step 93 requesting the user to remove the storage device. At steps 94 and 95, the storage device is removed and a message is then displayed requesting the user to enter a password. This is possible at step 96 because removal of the storage device unfreezes the input devices. Once the password is entered, it is compared to the password assigned to the temporary user account that was stored in the configuration file at step 90. If there is a match, the user is instructed to reinsert the removable storage device at step 97 and is permitted to copy files to the removable storage device at step 98. If there is no match at step 96, the program advances to step 99. At step 99 the program checks the alerts set at step 53 of the set up subroutine and issues the appropriate alerts at step 100. The system is designed so that the removable storage device cannot be used without entering the correct password. Thus, from step 100, the system reverts back to step 92.

The theft protection system of the present invention provides several additional security measures so that a user does not have the ability to copy all files even after entering the password for the temporary user account. First, in setting up the temporary user account at step 90, the administrator can designate which files the user is permitted to copy to the removable storage device and prohibit copying of the rest. Second, the system can create a log of all files copied by the user similar to the log created when a user attempts to delete a file. This can be checked to determine whether the user made unauthorized copies when logged in using the temporary user account. Third, the system can immediately notify the administrator if a specific file is requested by the user to be copied and require the administrator to enter a command authorizing copying of the specific file before the copy is actually made. Other similar safeguards can be employed without deviating from the invention.

FIG. 6 reflects still another safeguard, specifically the temporary nature of the user account. As shown, when the removable storage device is removed at step 101, the user account is deactivated at step 102 such that the user must obtain a new password from the administrator before the user can again copy files to a removable storage device. This feature can, of course, be implemented in alternative ways such as by automatically deactivating the user account after a specified period of time, automatically deactivating the account after a set number of times the account has been used, or deactivating the account when a specified number of files have been copied. Of course, it remains essential that the computer system be backed up regularly to a tape using a tape drive such as 14 or 36 or some other backup media. The setting up at parameters, and particularly the setup of backup authorization at step 53, permits the administrator to control backup operation. It is essential to protect against data theft to ensure that the media used with the backup storage device are physically safeguarded.

Those skilled in the art will recognize from the foregoing that once a removable storage device is, authorized for use in the computer system, files stored on the removable storage device can likewise be protected from undesired deletion just as files on other storage devices are protected. Files stored on the removable storage device which are the subject of a deletion command can be moved or copied to a recovery (i.e. dump) directory. This recovery directory can be located on the removable storage device itself or on some other storage device associated with the computer system. The software that controls the file deletion protection afforded by the present invention can also be stored on the removable storage device. This is particularly beneficial when the owner of the removable storage device is using it in conjunction with a computer system owned by a third party such as a library, school or business. In this case, the owner or user of the removable storage device is deemed to be the administrator and will receive messages regarding deletion of files. The recovery or dump directory can be password protected to ensure that files moved or copied there are not deleted by unauthorized personnel.

It should be clear from the foregoing, the system of the present invention protects against undesired destruction or theft of data stored on a computer system. At the same time, the system of the present invention provides flexibility in how legitimate deletion and copying of files can be accommodated. Those skilled in the art will recognize that the foregoing can be modified in any number of ways without deviating from the invention. The foregoing discussion is not intended to limit the scope of protection. The claims which follow define the scope of protection to be afforded to the invention.

What is claimed is:

1-24. (canceled)

25. A method for protecting data files stored on a storage device of a computer system, said computer system having a first mode of operation, at least one device capable of being used to copy files from said storage device to a removable storage device, and at least one recovery directory on a storage device, said method comprising:
a. detecting whether a removable storage device is present;
b. determining whether use of said removable storage device is unauthorized;
c. modifying the operation of the computer system from said first mode of operation to prevent copying of data files to an unauthorized removable storage device when an unauthorized removable storage device is present;
d. returning the operation of the computer system to said first mode of operation when the unauthorized removable storage device is no longer present or upon entry of a password of a user authorized to copy files to said removable storage device to authorize said removable storage device; and
e. upon receipt of a command to delete files, copying or moving at least some of said files to said recovery directory.

26. (canceled)

27. A method for protecting data files stored on a storage device of a computer system, the computer system having a first mode of operation and a second mode of operation, at least one device capable of being used to copy files from said storage device to a removable storage device, said method comprising:
a. determining whether a removable storage device is present;
b. determining whether use of said removable storage device is authorized or unauthorized for use with the computer system;
c. generating an alert if said removable storage device is unauthorized;
d. changing the mode of operation of said computer system from said first mode of operation to said second mode of operation if said removable storage device is unauthorized to prevent transfer of data files between an unauthorized storage device and the computer system; and
e. returning the operation of the computer system to said first mode of operation when the unauthorized removable storage device is no longer present or upon authorization of the unauthorized removable storage device.

28. The method of claim 27 wherein said alert is immediately transmitted to an administrator.

29. The method of claim 25 wherein the storage device of the computer system includes at least one recovery directory and, upon receipt of an instruction to delete a file, moves or copies the file to the recovery directory, access to said recovery directory otherwise being limited to a selected set of users.
